(19) United States
(12) Patent Application Publication
(10) Pub. No.: US 2008/0103847 A1
(43) Pub. Date: May 1, 2008

(54) Data Prediction for business process metrics

(76) Inventors: Mehmet Sayal, Mountain view, CA (US); Maria Guadalupe Castellanos, Sunnyvale, CA (US); Umeshwar Dayal, Saratoga, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/590,053

(22) Filed: Oct. 31, 2006

(51) Int. Cl. G06F 9/44

(52) U.S. Cl. 705/7

(57) ABSTRACT

Embodiments in accordance with the present invention include methods and systems for data prediction. A method includes analyzing time-series data in a business process with a single-metric technique and with a multiple-metric technique; and combining predictions from the single-metric technique and the multiple-metric technique to predict a predetermined change in the business process

### BACKGROUND

In competitive business environments, companies frequently desire to forecast events that influence business metrics and performance indicators. Indeed, such ability is often important for effective business planning. Information obtained from accurate event forecasts results in more efficient operations and cost savings for a business. For example, a business that forecasts particular requirements for the coming year can make profitable adjustments to its business practices based on this information. As another example, if a business can accurately predict potential failures or inefficiencies in a business process, then adjustments can be made to the business process to mitigate such problems.

By recognizing future trends, companies can potentially increase efficiency and gain a competitive advantage. Accurate recognition of such trends also results in significant cost savings and improved business processes.

Accordingly, improved methods and systems for data prediction are desirable.

### BRIEF DESCRIPTION OF THE DRAWINGS

FIG. 1 is an exemplary flow diagram for data prediction in accordance with an embodiment of the present invention.

FIG. 2A is a first diagram showing adjustment to weights for prediction computation in accordance with an embodiment of the present invention.

FIG. 2B is a second diagram showing adjustment to weights for prediction computation in accordance with an embodiment of the present invention.

FIG. 2C is a third diagram showing adjustment to weights for prediction computation in accordance with an embodiment of the present invention.

FIG. 2D is a fourth diagram showing adjustment to weights for prediction computation in accordance with an embodiment of the present invention.

FIG. 2E is a fifth diagram showing adjustment to weights for prediction computation in accordance with an embodiment of the present invention.

FIG. 2F is a sixth diagram showing adjustment to weights for prediction computation in accordance with an embodiment of the present invention.

FIG. 3 is a high-level diagram of system architecture for implementing an exemplary embodiment in accordance with an embodiment of the present invention.

FIG. 4 is a block diagram of an exemplary computer system in accordance with an embodiment of the present invention.

### DETAILED DESCRIPTION

Exemplary embodiments in accordance with the present invention are directed to systems and methods for data prediction. One exemplary embodiment analyzes business metrics or data, such as numeric variables that can be measured and recorded in a business process. The values of those metrics are typically measured and recorded over the course of time. The measurements for each metric are stored in the form of a time-series (i.e., a sequence of numeric measurements with timestamps indicating the time of measurement). Exemplary embodiments combine two different time-series analyses and prediction techniques, namely single-metric techniques (SMT) and multiple-metric techniques (MMT).

The single-metric techniques analyze the historic behavior of a single metric of the data and then build a model that fits such behavior to predict its future values. The techniques consider the different components of the time series data including its trend and seasonality.

The multiple-metric techniques perform a comparative analysis across multiple different metrics of the data and identify correlations among the changes in those metrics in order to predict their future values.

In both techniques, the business data is evaluated and used to predict or forecast future events. In one embodiment, the combination of SMT and MMT accurately predict potential failures or inefficiencies in a business process. Such predictions are used to adjust the business process and mitigate possible future problems. Thus, by recognizing future trends, embodiments in accordance with the present invention increase efficiency in business processes and enable companies to gain a competitive advantage. Accurate recognition of such trends also results in significant cost savings and improved business processes.

By way of example, the time-series data is evaluated to determine compliance with potential violations in one or more existing contracts, such as service level agreements (SLAs). Such evaluations compare predicted values with pre-defined thresholds to determine a likelihood of future violations with respect to terms and conditions in a SLA.

One exemplary embodiment combines predictions from SMT and MMT. This combination yields improved predictions that are complementary to each other. Therefore, the combination produces better accuracy than the individual techniques (i.e., using just an SMT or an MMT).

One exemplary embodiment applies single-metric and multiple-metric techniques separately on the input data. Exemplary embodiments then retrieve and combine the predictions from these two techniques about the future values of the data. If the input data consists of only one time-series, then only single-metric techniques are applicable. On the other hand, if the input data contains multiple time-series, then both techniques are applicable.

The predictions from single-metric techniques contain future timestamps and expected values of time-series data at those time stamps. Single-metric techniques generate predictions on future data values, and different algorithms are applicable for this purpose depending on the components of the time-series. Generally, more systematic components (i.e., trend and seasonality) in the series provide better or improved predictions over data with less systematic components. Further, more randomness contained in the series generally provides worse or less accurate predictions.

While the single-metric technique creates a model that captures the systematic and therefore deterministic behavior of the time-series, the multiple-series technique is able to cope with changes related to external events that cannot be captured with the single-series technique. Such external events are observed as random occurrences when only a single-metric approach is used. In contrast, when a multiple-metric approach is used, these occurrences are related to other events occurring in different metrics, and their expected impact is calculated. Therefore, by combining both SMT and MMT, exemplary embodiments leverage the strengths of the single-metric and multiple-metric techniques to overcome their individual limitations.

One exemplary embodiment relates to identifying time correlations (i.e., correlations between numeric values over the course of time) that indicate time-based relationships among data objects (time-series data). Such embodiments automatically determine time correlations among numeric data and generate time correlation rules used for analysis, predictions, and reporting purposes.

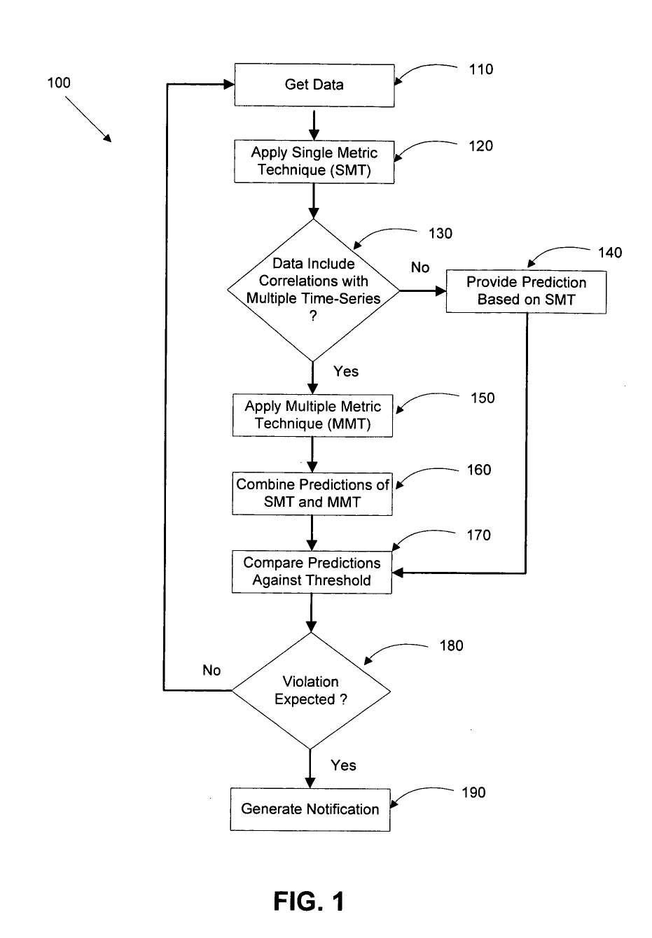

FIG. 1 is an exemplary flow diagram 100 for data prediction in accordance with an embodiment of the present invention. The diagram combines predictive techniques from both SMT and MMT.

According to block 110, data for the predictive techniques is obtained. In one exemplary embodiment, the input data is any kind of data stream that is time-stamped (i.e., “time-series” data). Further, input data is obtained from any one or more of a variety of sources, such as from one or more storage devices/arrays, database tables, extensible markup language (XML) documents, flat text files with character delimited data fields, etc.

Data values of numeric data objects are often recorded with time-stamps as snapshots of time, thus yielding time-series data. Embodiments of the present invention comprise methods usable for automatically determining correlations within either or both of single time-series data and multiple time-series data. Further, time correlations include such information as correlation type (e.g., same or opposite direction), sensitivity (e.g., the magnitude of change in the value of one data object compared to the change in values of other data objects), and time distance between changes (e.g., time delay), to name a few examples.

According to block 120, one or more single metric techniques (SMTs) are applied to the data. Single-metric techniques normally do not calculate a confidence associated with their predictions. Instead, such techniques simply generate predicted values for future time points. However, it is possible to assign confidences to a predicted value based on the detected characteristics of the input data. For example, if the single-metric techniques cannot detect any trend or seasonal behavior, one exemplary embodiment assigns a low confidence to these predictions. On the other hand, if trend and/or seasonal behavior exist, one exemplary embodiment assigns high confidence to the predictions of single-metric techniques. Also, from the error calculated for the model fitness on the seen and unseen parts of the time series, a confidence value can be derived.

According to block 130, a question is asked: Does the data include correlations among multiple time series? If the answer to this question is “no” then flow proceeds to block 140 wherein predictions are generated based on the SMT. Here, data relates to a single variable. If the answer to this question is “yes” then flow proceeds to block 150. Here, data relates to multiple variables with at least two variables having correlations.

According to block 150, one or more multiple metric techniques (MMTs) are applied to the data. Unlike SMTs which perform analysis on single time-series, multiple-metric techniques perform a comparative analysis among multiple time-series. MMTs generate predictions in the form of expected changes in the future. For instance, such techniques include the amount of change, direction of change (up or down), expected start time of the change, and the confidence of the prediction (i.e., how likely it is for the predicted change to actually occur). In one exemplary embodiment, the multiple-metric techniques generate those predictions only when there are correlations among the changes of data values in different time-series. Those correlations are detected and reported to explain expected future changes in time-series data values.

According to block 160, the predictions of the one or more SMTs and the predictions of the one or more MMTs are combined. According to block 170, the predictions are compared against one or more pre-existing thresholds. The comparison is assessed and according to block 180, a question is asked: Does the comparison reveal that a violation is expected? If the answer to this query is “no” then flow proceeds back to block 110. If the answer to this question is “yes” then flow proceeds to block 190 wherein one or more notifications are generated. By way of example, a user or system administrator is alerted as to the possibility of a future violation. Such notification can also include a report of the analysis, recommendations to remedy the potential violation, cost analysis to remedy the violation, etc.

Turning back now to block 160 wherein the predictions are combined. In one exemplary embodiment, several characteristics are utilized for this combination. First, single-metric techniques generally always generate predicted future values of time-series data, but those predictions are more likely to be accurate when trend or seasonal behavior exists in the input data. Second, multiple-metric techniques generally only generate predictions for future changes when correlations exist among significant changes of data values from different time-series.

These two characteristics are utilized to generate or define a set of rules for combining the predictions from single-metric and multiple-metric techniques. The set of rules are described as follows:
(1) When correlations are not detected by the multiple-metric techniques, the combining step will always consider the predictions from single-metric techniques.
(2) When there is no good or accurate model from the single-metric technique that fits the behavior of the series, but the multiple-metric approach detects correlations among different time-series, the combining step will consider only the predictions from the multiple-metric techniques. In this case, the predictions will only occur when there are correlated changes.
(3) When a single-metric technique finds a model and a multiple-metric technique detects correlations, the predictions of the single-metric technique are used as the basis and are adjusted by the predictions of the multiple-metric technique only when there are correlated changes for that particular time instance.

The third rule is illustrated with the following example. Assume that the value predicted by the single-metric technique for a future time instance t is value(t). In addition, assume that the multiple-metric technique detects a change in another time-series whose changes are correlated to the time-series for which the prediction is being made. The impact is expected to be observed at the future time instance t; the predicted value value(t) is modified by the amount of expected change changeamount(t) that is reported by the multiple-metric technique, which is called adjusted prediction. This adjusted prediction is computed as follows:

adjustedprediction(t)=value(t)+changeamount(t)

The single-metric and adjusted predictions are combined using weighted formula that reflects user-defined importance or accuracy of each of them. For example, assuming that single-metric techniques predicted the future value at time t as value(t), and the adjusted prediction for the same future time instance t is adjustedprediction(t), the combined prediction is calculated as follows:

CombinedPrediction=weight1*value(t)+weight2*adjustedprediction(t).

In this equation, weight1 and weight2 are the assigned weights of single-metric and adjusted prediction respectively, and those weights have values between 0 and 1. To illustrate this, assume the following values:

value(t)=8

adjustedprediction(t)=value(t)+changeamount(t)=8+2=10

weight1=0.5

weight2=0.5

then the combined prediction is

CombinedPrediction=0.5*8+0.5*10=9.

In one exemplary embodiment, weights have an important function in the computation of the combined prediction. Therefore, exemplary embodiments make the assignment of weights flexible enough to consider various possibilities. By way of example, weights are assigned according to one of a static approach, a dynamic approach, and/or a confidence-based approach.

In the static weight approach, the single-metric and the adjusted predictions are manually assigned fixed weights depending on the subjective importance that the user gives to correlated changes in other time series. In other words, weights are pre-assigned and fixed (i.e., constant) for both SMT and MMT over a given time period.

In the dynamic weight approach, the weights of single-metric and adjusted predictions are updated depending on how accurate their values were. Here, weights are initially pre-assigned, but such weights are not fixed, but variable (i.e., able to change over time). For example, assume that value(t) and changeamount(t) are the predicted value and the change amount for future time t by single-metric and multiple-metric techniques respectively. The predicted value value(t) and the adjusted predicted value adjustedprediction(t) are compared against the actual value, say actualvalue(t), at time t when that time comes. In this case, the actualvalue(t) will be compared against the following two values:
(1) value(t), which is the prediction of the single-metric technique; and
(2) adjustedprediction(t)=value(t)+changeamount(t), which is the prediction of the single-metric technique adjusted by the change amount predicted by the multiple-metric technique.

If the actualvalue(t) is closer to the adjustedprediction(t), then the multiple-metric technique is contributing to increasing the accuracy. Therefore, the weight of multiple-metric technique is increased by a factor f while the weight of the single-metric technique is decreased by the same factor.

In the confidence-based approach, assume that both SMT and MMT generate both a prediction and a confidence associated with that prediction. By way of example, assume that the SMT has a confidence of 0.8 or 80%, and that the MMT has a confidence of 0.6 or 60%. The respective weights are determined by dividing the confidence of each technique by the sum of the confidences. Thus, the weight of SMT is 0.8/(0.8+0.6)=0.57 or 57%. The weight of the MMT is 0.6/(0.8+0.6)=0.43 or 43%.

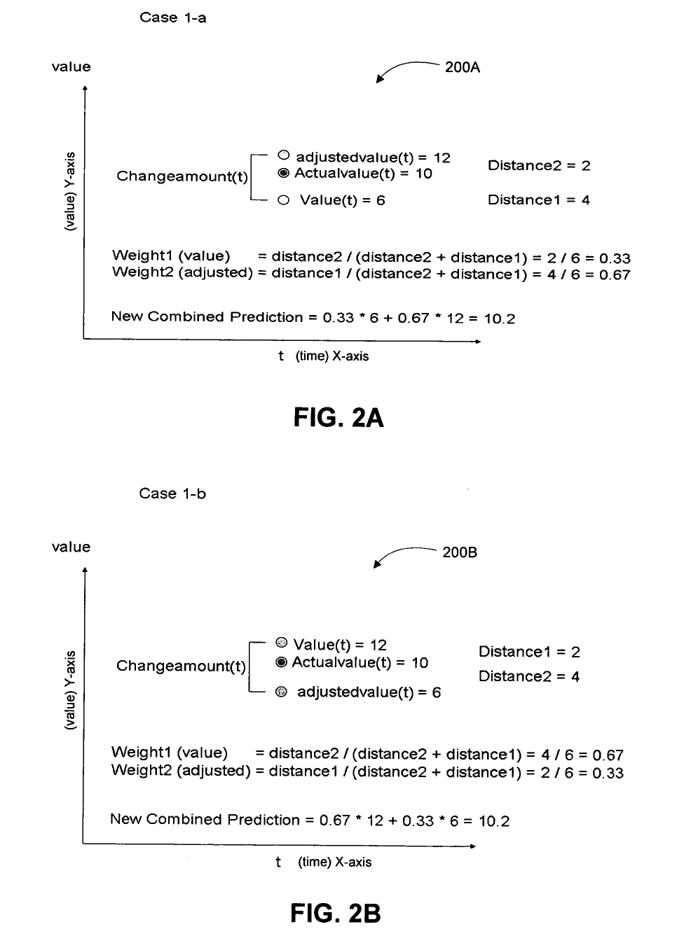

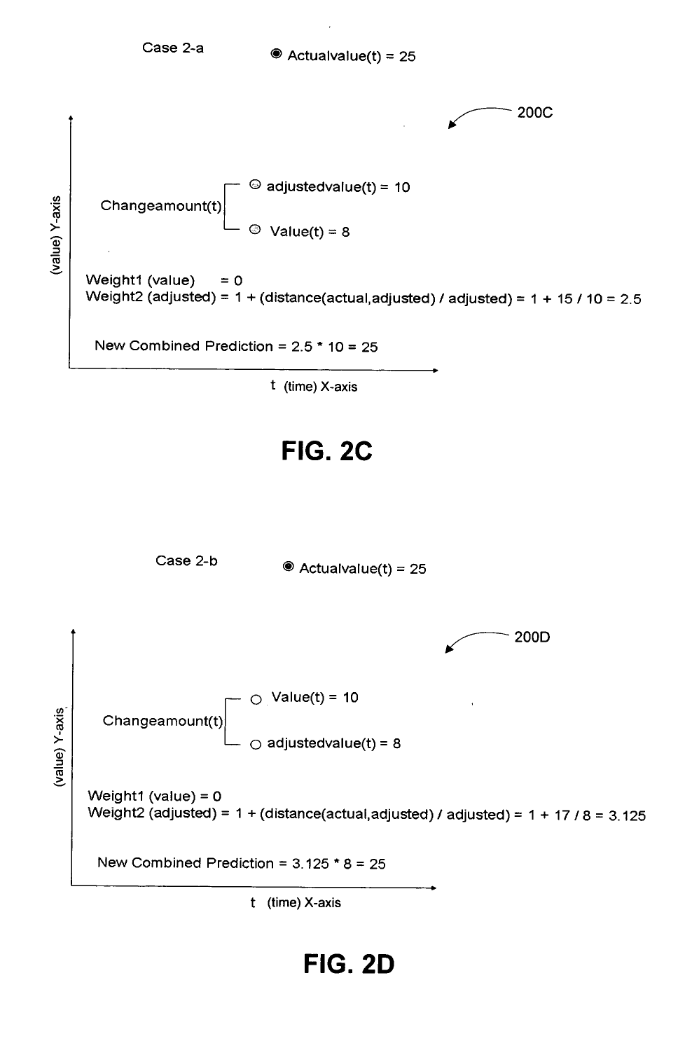

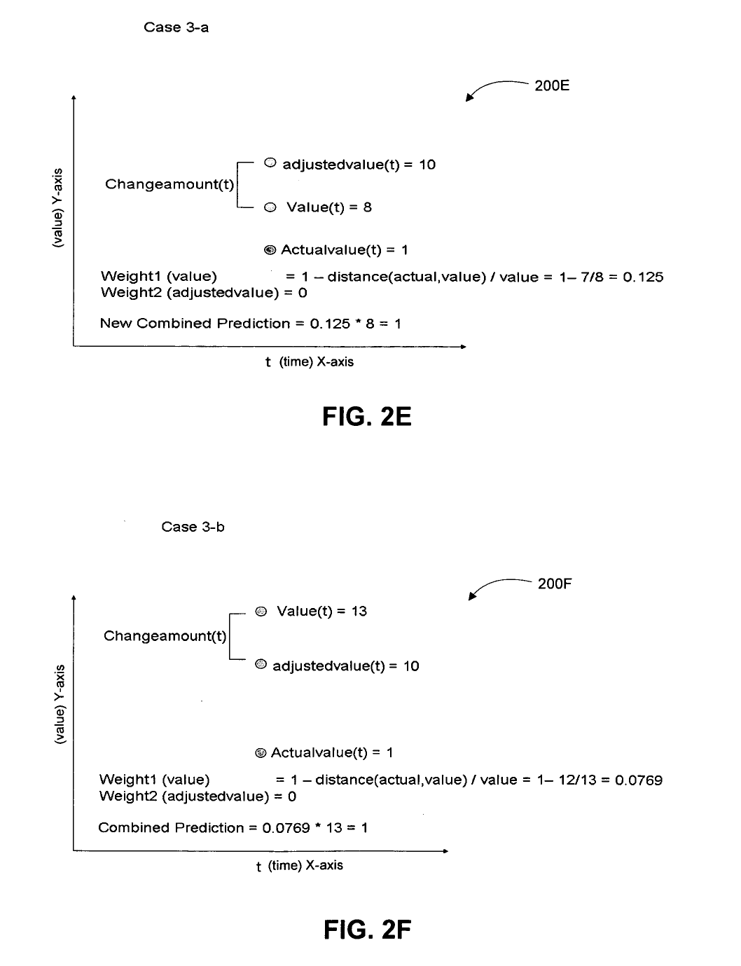

The adjustments to the weights are explained in the FIGS. 2A-2F for various scenarios. FIGS. 2A shows a first diagram 200A and FIG. 2B shows a second diagram 200B illustrating that the actual value (i.e., Actualvalue(t)) is between the single-metric (Value(t)) and adjusted predictions (adjustedvalue(t)). In this case the weights should add up to one, and they should be proportional to how close those predictions are to the actual value.

FIG. 2C shows a third diagram 200C and FIG. 2D shows a fourth diagram 200D wherein the actual value (i.e., Actualvalue(t)) is larger than both the single-metric (Value(t)) and adjusted predictions (adjustedvalue(t)).

FIG. 2E shows a fifth diagram 200E and FIG. F shows a sixth diagram 200F wherein the actual value (i.e., Actualvalue(t)) is smaller than both the single-metric (Value(t)) and adjusted predictions (adjustedvalue(t)).

In each of those six cases (FIGS. 2A-2F), exemplary embodiments distinguish two sub-cases depending on which of the single-metric and adjusted predictions is closer to the actual value. The confidence of the combined prediction is also a combination of the confidence values reported by the individual techniques.

In one exemplary embodiment, the multiple-metric technique continuously updates the detected correlations. Therefore, when a correlation becomes invalid, the multiple-metric technique stops calculating the adjusted value based on that correlation. Similarly, when new correlations are detected, the multiple-metric technique starts calculating the change amounts related to those correlations.

Embodiments in accordance with the present invention are applicable to many different computational fields, including data analysis, reporting, data mining, data integration, and so forth, to automatically discover time correlations in numeric data. Such time correlations are further utilized in a variety of embodiments, such as business impact analysis, forecasting, prediction, simulation, and so forth. In order to illustrate the diverse applicability of exemplary embodiments, an example is provided to contracts or service level agreements (SLAs).

One exemplary embodiment is a hybrid approach that combines multiple techniques for early detection of Service Level Agreement (SLA) violations. SLAs consist of Service Level Objectives (SLO) that present certain goals, thresholds for determining whether the goals are met, and compensation procedures in case a violation occurs. Each SLO statement involves one or more information technology (IT) or business metrics that are usually numeric variables that can be measured and recorded. The values of those metrics are typically measured and recorded over the course of time. The measurements for each metric can be stored in the form of a time-series (i.e., a sequence of numeric measurements with timestamps indicating the time of measurement).

Business processes are often tied to or governed by terms and conditions stipulated in contracts and service level agreements. In general, a SLA is an agreement between two entities, such as a telecommunication entity or IT entity and a customer. The agreement specifies services that the entity will provide the customer and the terms and conditions involved with such services.

In one exemplary embodiment, an SLA defines parameters such as the type of service being provided, data rates, penalties/rewards, and expected performance levels in terms of error rates, delays, port availability, response time, repair, etc. For instance, a SLA provides terms and conditions for an IT entity to perform a variety of organizational tasks, such as providing data storage, facilitating communication, and automating services. An organization's IT infrastructure of computer systems, networks, databases, and software applications is responsible for accomplishing these organizational tasks.

As used herein, a contract is a binding agreement between two or more persons, parties, and/or entities. A service level agreement (SLA) is an example of a contract. A SLA is an agreement between a customer or user and an entity, such as a service provider. The SLA, for example, can stipulate and commit the entity to provide the user with a required level of service. A SLA can contain various terms and condition, such as a specified level of service, support options, enforcement or penalty provisions for services not provided, a guaranteed level of system performance as related to downtime or uptime, a specified level of customer support, software or hardware for a specified fee, to name a few examples. The service provider can be, for example, an application service provider (ASP). An ASP manages and distributes software-based services and solutions from a central data center to customers across a network (such as a wide area network (WAN)).

One exemplary embodiment combines multiple approaches in order to achieve better accuracy in early detection of SLA violations. The existing single-metric and multiple-metric approaches display their strengths under different cases, which are complementary to each other. By way of example, the single-metric techniques include one or more statistical approaches such as autoregressive integrated moving average (ARIMA) and Holt-Winters. Those techniques distinguish trend and seasonal behavior from the noise in order to predict the future values of the business metrics. The predicted values are then compared against the SLO thresholds in order to detect future SLA violations.

In contrast to SMT, multiple-metric techniques apply comparative analysis of multiple business metrics in order to identify any correlations in their behavior. Those correlations are used for predicting the future behavior of individual metrics. By way of example, such time-series depict random-walk behavior or otherwise do not follow any particular trend or seasonal pattern. Therefore, it is difficult to predict its future behavior using single-metric techniques. On the other hand, a multiple-metric comparison can yield better results.

The proposed method takes advantage of the complementary aspects of different prediction techniques to detect future SLA violations more accurately than with individual techniques (i.e., using only SMT or only MMT). Exemplary embodiments are thus capable of dealing with both the systematic behavior of a time series as well as with random changes.

Exemplary embodiments recognize that single-metric techniques generate good predictions when a systematic (e.g., trend or seasonality) behavior is detected or when the time series fits a certain curve (line, exponential, hyperbolic, etc). However, as more randomness exists in the series, the models are less and less accurate. A similar deficiency occurs with traditional multi-variable (multi-series) techniques where the model takes into account not only the time series itself, but also other series which affect the behavior of the first one. Random changes on such series cannot be captured in the model. On the other hand the multiple-metric techniques generate good predictions when correlations exist among the random changes in the values of two or more time-series but do not capture any other aspect of the behavior. Generally, single use of SMT or MMT is limited; either they are able to handle systematic behavior or they handle random changes, but not both.

As noted in connection with block 190, notification is generated in the event of a predicted failure or violation. If the violation impacts other services, then a list of impacted services could be determined and a notification sent to the service provider. For example, an alarm is sent to the service provider if predicted measurements of service parameters violate thresholds established in a SLA or other business process.

Further, a wide range of failures or violations can be predicted, depending on the business process or metrics being evaluated. Examples are provided with respect to SLAs merely to illustrate breadth with regard to one business process. Thus, by way of example, such failures include non-compliance (example, by a customer with respect to terms and conditions in a SLA), faults (example, a server of the service provider fails), violations of a SLAs (example, violation on the part of the service provider or the customer), degradations, etc. Each specific-level SLA will have a set of requirements that must be met in order to be in compliance. For instance, for SLAs related to database systems, a transaction time or throughput measurement can be a requirement. Various level SLAs can have a different trigger, or threshold, defined for a given measurement type. These triggers are input and defined in the contract management system. For example, measurements for a SLA can include throughput, disk space and availability. Different level SLAs will have different triggers/thresholds.

Another aspect of defining triggers is to define a method or means of notification when the threshold is exceeded. For example, the trigger can be defined as the notification point, and the threshold can be defined as the non-compliance point. An e-mail, fax, or pager notification could be sent when the threshold is approached or predicted occurring. Further, different warnings (such as a low, medium and high) can be utilized for varying non-compliance thresholds. Further yet, alarms, failures, violations, etc. may be reported, printed, transmitted, etc.

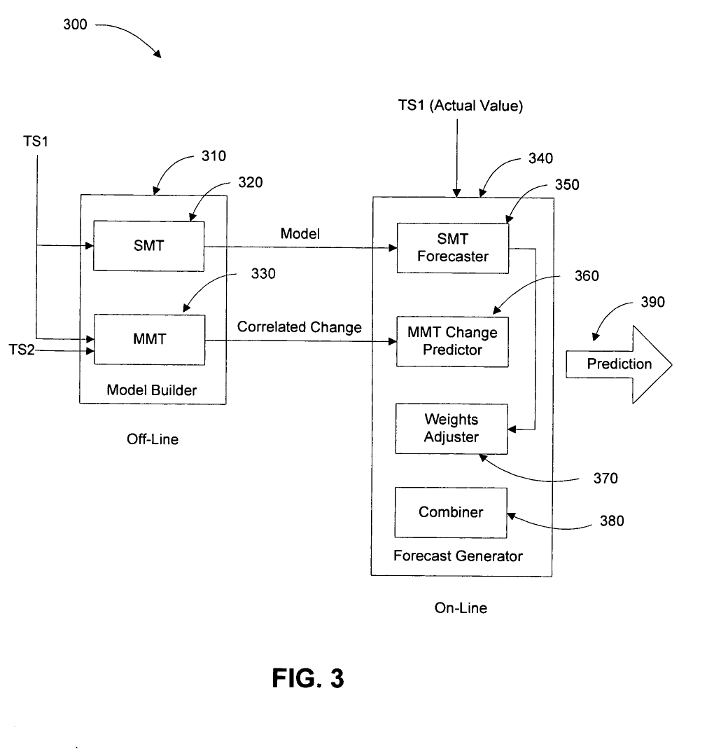

FIG. 3 is a high-level diagram of system architecture 300 for implementing an exemplary embodiment in accordance with an embodiment of the present invention. The architecture generally includes a model builder 310 and a forecast generator 340. The model builder includes an SMT model builder 320 and an MMT model builder 330. The Forecast generator 340 includes an SMT forecaster 350, an MMT change predictor 360, a weights adjuster 370, and a combiner 380.

In one exemplary embodiment, time-series data (TS1) is input into the forecast generator 340 and the model builder 310 (namely, to the SMT model builder 320 and MMT model builder 330). A second input is shown as time-series data (TS2). This data is input only to the MMT model builder 330. By way of example, TS1 could be data applicable for single-metric techniques, and TS2 data applicable for multiple-metric techniques.

The SMT model builder 320 outputs a model to the SMT forecaster 350, and the MMT model builder 330 outputs correlated change to the MMT change predictor 360. If the input time-series data does not include correlations with multiple time-series, then the forecast generator 340 generates and outputs a prediction 390 that is based exclusively on the SMT forecaster 350. On the other hand, if the input time-series data does include correlations with multiple time-series, then the forecast generator 340 uses the combiner 380 to combine output from the SMT forecaster 350 and MMT change predictor 360 to generate the prediction 390. Further, as noted in connection with FIG. 1, one or more weight formula or weight adjustments can be applied using a weight adjuster 370 to the outputs to improve accuracy of the prediction.

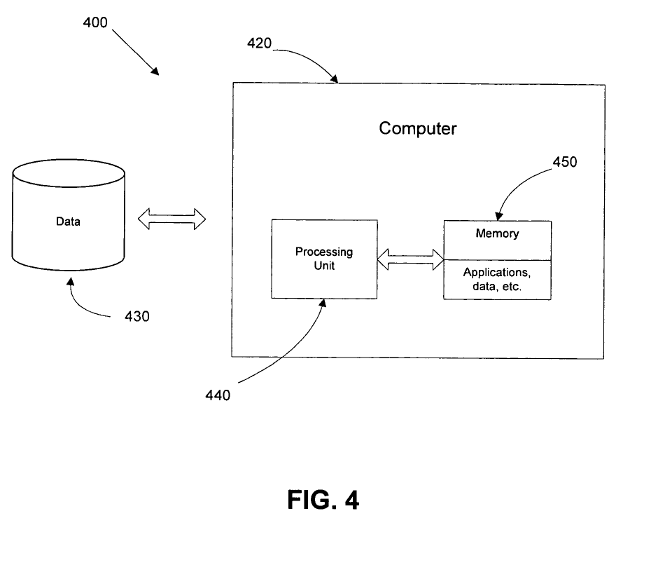

Embodiments in accordance with the present invention are utilized in or include a variety of systems, methods, and apparatus. FIG. 4 illustrates an exemplary embodiment as a computer system 400 for being or utilizing one or more of the computers, methods, flow diagrams and/or aspects of exemplary embodiments in accordance with the present invention.

The system 400 includes a computer system 420 (such as a host or client computer) and a repository, warehouse, or database 430. The computer system 420 comprises a processing unit 440 (such as one or more processors of central processing units, CPUs) for controlling the overall operation of memory 450 (such as random access memory (RAM) for temporary data storage and read only memory (ROM) for permanent data storage). The memory 450, for example, stores applications, data, control programs, algorithms (including diagrams and methods discussed herein), and other data associated with the computer system 420. The processing unit 440 communicates with memory 450 and data base 430 and many other components via buses, networks, etc.

Embodiments in accordance with the present invention are not limited to any particular type or number of databases and/or computer systems. The computer system, for example, includes various portable and non-portable computers and/or electronic devices. Exemplary computer systems include, but are not limited to, computers (portable and non-portable), servers, main frame computers, distributed computing devices, laptops, and other electronic devices and systems whether such devices and systems are portable or non-portable.

Further, embodiments in accordance with the present invention are not limited to any particular single-metric technique or multiple-metric technique. By way of example, U.S. patent application Ser. No. 11/272,211 entitled “System and Method for Data Prediction” discloses single-metric techniques and is incorporated herein by reference. Further, U.S. patent application Ser. No. 10/873,556 entitled “System and Method for Correlation of Time-Series Data” discloses multiple-metric techniques and is incorporated herein by reference.

In one exemplary embodiment, one or more blocks or steps discussed herein are automated. In other words, apparatus, systems, and methods occur automatically. As used herein, the terms “automated” or “automatically” (and like variations thereof) mean controlled operation of an apparatus, system, and/or process using computers and/or mechanical/electrical devices without the necessity of human intervention, observation, effort and/or decision.

The methods in accordance with exemplary embodiments of the present invention are provided as examples and should not be construed to limit other embodiments within the scope of the invention. For instance, blocks in flow diagrams or numbers (such as (1), (2), etc.) should not be construed as steps that must proceed in a particular order. Additional blocks/steps may be added, some blocks/steps removed, or the order of the blocks/steps altered and still be within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method of software execution, comprising:
combining (1) a single-metric technique that analyzes behavior of a single metric of a business process with (2) a multiple-metric technique that performs a comparative analysis across multiple metrics of the business process so as to predict a predetermined change in the business process.

2) The method of claim 1 further comprising:
storing a sequence of numeric measurements indicating a time of measurement for the business process;
using at least a portion of the numeric measurements in the single-metric technique and in the multiple-metric technique.

3) The method of claim 1 further comprising:
storing the single metric as a time-series;
using the time-series to build a model with the single-metric technique to predict future values in the business process.

4) The method of claim 1 further comprising:
using the multiple-metric technique to identify correlations among changes in the multiple metrics to predict future values for the multiple metrics.

5) The method of claim 1 further comprising:
separately applying the single-metric technique and the multiple-metric technique to historical data from the business process to generate plural predictions;
combining the plural predictions to generate a prediction about a future violation in the business process.

6) The method of claim 1 further comprising:
evaluating a sequence of numerical data with timestamps indicating a time of measurement.

7) The method of claim 1 further comprising:
using the single-metric technique to generate a prediction that includes future timestamps and expected values for time-series data at the time stamps;
using the multiple-metric technique to generate a prediction that includes expected changes at a future time with amount of change, direction of the change, and expected start time of the change.

8) A computer readable medium having instructions for causing a computer to execute a method, comprising:
analyzing time-series data in a business process with a single-metric technique and with a multiple-metric technique; and
combining predictions from the single-metric technique and the multiple-metric technique to predict a predetermined change in the business process.

9) The computer readable medium of claim 8 further comprising:
generating predictions with the multiple-metric technique only when correlations exist among changes of data values in different time-series.

10) The computer readable medium of claim 8 further comprising:
building a model with the single-metric technique based on the time-series data to predict a violation in the business process;
adjusting predictions from the model with predictions from the multiple-metric technique.

11) The computer readable medium of claim 8 further comprising:
applying a weighted formula to predictions from the single-metric technique and predictions from the multiple-metric technique to more accurately predict a violation in the business process.

12) The computer readable medium of claim 8 further comprising:
using the single-metric technique to generate a prediction for a future value at time t as value(t);
multiplying the value(t) by a static weight that does not change over time.

13) The computer readable medium of claim 8 further comprising:
using the single-metric technique to generate a prediction for a future value at time t as value(t);
multiplying the value(t) by a dynamic weight that changes over time to increase an accuracy of the prediction.

14) The computer readable medium of claim 8 further comprising:
comparing the predictions against thresholds of objectives in a service level agreement (SLA) so as to detect future violations in the SLA.

15) The computer readable medium of claim 8 further comprising,
generating predictions with the multiple-metric technique only when a correlation exists between changes of data values in the time-series data.

16) A computer system, comprising:
a memory for storing an algorithm; and
a processor for executing the algorithm to:
generate a first prediction with a single-metric technique that analyzes behavior of a single metric of a business process;
generate a second prediction with a multiple-metric technique that performs a comparative analysis across multiple metrics of the business process;
combine the first and second predictions to predict a predetermined change in the business process.

17) The computer system of claim 16, wherein the processor further executes the algorithm to determine if a correlation exists among changes of data values from different time-series data from the business process.

18) The computer system of claim 16, wherein the processor further executes the algorithm to consider only predictions from the single-metric technique when correlations with different time-series data are not detected with the multiple-metric technique.

19) The computer system of claim 16, wherein the single-metric technique and the multiple-metric technique are different techniques that independently predict violations in the business data.

20) The computer system of claim 16, wherein the processor further executes the algorithm to use the single-metric technique to distinguish trend and seasonal behavior from noise in time-series data from the business process so as to predict future values for the business process.
